(19) United States
(12) Patent Application Publication
(10) Pub. No.: US 2006/0189723 A1
(43) Pub. Date: Aug. 24, 2006

(54) Coatable urea-aldehyde compositions containing a cocatalyst, coated abrasives made using same, and methods of making coated abrasives

(76) Inventors: Jeffrey E. Ford, Saint Paul, MN (US); Harold E. Rude, Saint Paul, MN (US)

Correspondence Address: NIXON & VANDERHYE, PC, 901 NORTH GLEBE ROAD, 11TH FLOOR, ARLINGTON, VA, 22203, US

(21) Appl. No.: 10/565,963

(22) PCT Filed: Jul. 27, 2004
(86) PCT No.: PCT/NL04/00540

§ 371 Date: Feb. 28, 2006

(30) Foreign Application Priority Data
Jul. 28, 2003 (NL) 1024010
Aug. 4, 2003 (NL) 1024036
Sep. 18, 2003 (NL) 1024319

(51) Int. Cl. B29C 47/00

(52) U.S. Cl. 524/13; 524/35; 528/230

(57) ABSTRACT

The invention relates to an adhesive composition comprising a formaldehyde-containing aminoplast resin and a catalysing compound, with the catalysing compound being an acid or is able to release an acid with a pKa lower than 4 and with the formaldehyde-containing aminoplast resin having a F/(NH2)2 ratio lower than or equal to 1. The catalysing compound comprises at most 11 wt. % of an ammonium salt. The invention also relates to a process for the preparation of board material using the adhesive composition according to the invention and to the board material thus obtainable.

The invention relates to an adhesive composition comprising a formaldehyde-containing aminoplast resin and a catalysing compound.

Such an adhesive composition is disclosed in for example EP-436.485-A2. This patent publication describes a process for accelerated curing of aminoplast adhesives and wood-based materials manufactured therewith. The adhesive composition described in said patent application comprises a urea-formaldehyde (UF) resin with a molar F/U ratio of 1.11. Ammonium sulphate is applied as a catalysing compound. For the accelerated curing of these aminoplast adhesives an accelerator scavenger system is applied, there being added to the adhesive a urea formaldehyde mixture as an accelerator and a formaldehyde scavenger. Adding the formaldehyde scavenger prevents an increase in the formaldehyde emission from the board material manufactured with the adhesive.

In view of environmental regulations the formaldehyde emission during and after the manufacture of the board material is very important. For example, NEN EN 312-1 defines for particle board a class 1 board, for which it holds that the formaldehyde potential must not be higher than 8 mg per 100 g dry cellulose-containing material. Formaldehyde potential refers to the quantity of formaldehyde obtained by the extraction method described in DIN NEN 120, also known as the Perforator test; the formaldehyde potential of a material is indicative of its formaldehyde emission. The class 1 requirement for particle board is a stringent requirement with which the formaldehyde potential of particle board material must comply, and illustrates the trend for emission requirements to be tightened up.

It has now surprisingly been found that when an adhesive composition according to the invention is applied for the production of board material the emission of formaldehyde is very low; for particle board, for example, the formaldehyde potential according to DIN NEN 120 can be less than 10 and in many cases even less than 8 mg/100 g of dry cellulose-containing material. At the same time the curing time and the final properties of the board material are not adversely influenced.

The adhesive composition according to the invention is characterised in that the catalysing compound is an acid or is able to release an acid with a pKa lower than 6, under the proviso that the catalysing compound comprises at most 11 wt. % of an ammonium salt, and in that the formaldehyde-containing aminoplast resin possesses an F/(NH₂)₂ ratio which is lower than or equal to 1.

In EP 107260 A1, a process of manufacturing sheets is disclosed in which an adhesive composition is used having a molar F/(NH₂)₂ ratio between 0.50 and 1.25. EP 107260 A1 discloses as catalysing compound a mixture of an ammonium salt with a strong acid. The catalysing compound mixtures disclosed in EP 107260 A1 comprise more than 11 wt. % of an ammonium salt.

The catalysing compound according to the invention can be an acid with a pKa lower than 6 or a compound able to release an acid with a pKa lower than 6. The pKa of the acid is determined at 25° C.

Acids with a pKa lower than 6 are known per se. Examples of such acids are formic acid, lactic acid, glyoxylic acid, maleic acid, fumaric acid, phthalic acid (o, m and p), salycic acid, p-toluenesulfonic acid, sulfuric acid, phosphoric acid, tartaric acid, uric acid, hydrochloric acid solution, acetic acid, benzoic acid, succinic acid and furan carboxylic acid.

A compound able to release an acid refers to a compound which in the preparation and/or application of the adhesive composition reacts in such a way, for example because the compound decomposes, that an acid is formed. Examples of compounds able to release an acid with a pKa lower than 6 are alkyl esters such as methyl esters, melamine or urea salts of one or more of the said acids and methylolated urea or melamine compounds esterified with one or more of the said acids. Examples of methyl esters are methyl glyoxylate, methyl citrate, methyl formiate, methyl phosphate and methylureate. In general the methyl esters of acids with a pKa lower than 6 can be applied.

Examples of melamine salts or urea salts are melamine formiate, melamine citrate, urea lactate and urea ureate. In general the melamine salts or urea salts of acids with a pKa lower than 6 can be applied.

Esters of methylolated urea or melamine compounds can be synthesised according to the following reaction: 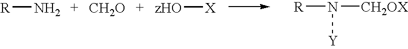
where R—NH₂ originates from melamine or urea, HO—X originates from an acid with a pKa lower than 6, Y may be equal to H or CH₂OX and z is equal to 1 or 2.

Preferably, compounds able to release an acid release at least 50% of the acid within 1 minute at 90° C. in water.

The catalysing compound according to the invention should not comprise more than 11 wt. % of an ammonium salt. Within the context of the present invention, the term ‘an ammonium salt’ also encompasses mixtures of various ammonium salts. Known examples of ammonium salts are ammonium chloride and ammonium sulphate. It was found that these salts can, in particular during curing of the adhesive composition, react with formaldehyde to form relatively instable compounds such as hexamethylenetetramine (HMTA). This reaction reduces the formation of the three-dimensional adhesive network as intended during curing, leading to reduced properties of the end product as evidenced in a reduced chemical resistance, reduced hydrolysis resistance, reduced internal bond strength, or increased swelling upon contact with water. Furthermore, compounds such as HMTA can decompose and thereby lead—on shorter and/or on longer term—to a formaldehyde emission, as evidenced in the formaldehyde potential test according to NEN-EN 120 (Perforator test). Consequently, the use of ammonium salts can have a negative effect on a main objective of the present invention, being the reduction of formaldehyde emission, in particular when adhesive compositions are used with a molar F/(NH₂)₂ ratio of 1 or lower. Preferably, the catalysing compound according to the invention comprises at most 10 wt. % or 8 wt. % of an ammonium salt; more preferably, the catalysing compound according to the invention comprises at most 6 wt. % or 4 wt. % of an ammonium salt; in particular, the catalysing compound according to the invention comprises at most 2 wt. % or 1 wt. % of an ammonium salt; most preferably, the catalysing compound according to the invention comprises at most 0.5 wt. % or 0.1 wt. % of an ammonium salt, or even no ammonium salt at all.

In a preferred embodiment of the adhesive composition according to the invention, the catalysing compound comprises at most 11 wt. % of salts of primary amines (primary amines are compounds having a R—NH₂ structure) or salts of secondary amines (secondary amines are compounds having a RR′—NH structure, whereby R and R′ are not hydrogen). In other, more preferred embodiments, these salts of primary or secondary amines are present in even lower quantities, such as the quantities indicated above for ammonium salts.

It is of course also possible for the catalysing compound to comprise one or more of the aforementioned acids, combined with one or more of the aforementioned compounds able to release an acid. The catalysing compound may also comprise more than one acid or more than one compound able to release an acid.

A compound able to release an acid can be applied for example when it is desirable for the adhesive composition to be stored for some time at room temperature. In that case it is preferable to choose a compound which only decomposes at a temperature higher than room temperature, so that the catalysing effect only occurs during the manufacture of the board material.

Preferably the catalysing compound is an acid with a pKa lower than 5, or a compound able to release an acid with a pKa lower than 5. This has the advantage that it is easier to achieve a reduction of the pH of the adhesive composition to the desired level of normally 7 or even lower, such as 6. A further advantage is that with a reduced pKa it is possible to achieve a shorter gel time. Gel time is defined as the time required for gelling after 5 grams of catalysed resin are introduced into water in a test tube and the contents are stirred in boiling water.

Still more preferably the catalysing compound is an acid with a pKa lower than 4 or compound able to release an acid with a pKa lower than 4. This has the advantage that it is easier to achieve lower pH values in the adhesive composition than with acids—or compounds able to release an acid—with a pKa between 4 and 6; a further advantage is that the quantity of catalyst to be metered is lower than with acids—or compounds able to release an acid—with a pKa between 4 and 6; since this catalyst will normally be dosed in the form of an aqueous solution, less water ends up in the adhesive composition, which is desirable since it is advantageous for an adhesive composition to have as high a solids content as possible.

Preferably the catalysing compound is a monoacid or a methyl ester, melamine salt or urea salt of one or more monoacids with a pKa lower than 4 or a methylolated urea or melamine compound esterified with one or more monoacids with a pKa lower than 4. A monoacid is an acid that can release only one hydrogen ion (proton).

With special preference the catalysing compound is formic acid or a methyl ester, melamine or urea salt of formic acid or a methylolated urea or melamine compound esterified with formic acid.

Most preferably the catalysing compound is formic acid. In yet another preferred embodiment, however, the catalysing compound is acetic acid.

It is possible to combine the catalysing compound according to the invention, which is an acid or a compound able to release an acid with a pKa lower than 6, in the adhesive composition to a greater or lesser degree with known catalysts such as ammonium sulphate, whereby as indicated above the total amount of catalysing compound should not comprise more than 11 wt. % of an ammonium salt; in a preferred embodiment of the invention, however, this is not practiced and no other catalyst is applied.

Although a theoretical explanation is still unknown, the assumption is that the limited buffering effect of (released) acids with a very low pKa has an adverse on the performance of the adhesive composition according to the invention. Preferably therefore the catalysing compound is an acid with a pKa higher than −14, or a compound which able to release an acid with a pKa higher than −14; more preferably the said pKa is higher than −10, still more preferably higher than −6, and most preferably higher than −3.

In the present invention there are applied as aminoplast resin condensation products of at least an amino compound and a free formaldehyde-like compound.

As amino compound in these aminoplast resins both acyclic and heterocyclic amino compounds are applicable. Examples of acyclic amino compounds are urea, thiourea or ethylurea. As heterocyclic amino compounds are applied for example compounds which have a triazine structure, such as melamine, melam, higher condensation products of melamine, ammeline, ammelide, cyanuric acid and ureidomelamine. Preferably urea and/or melamine are used. More in particular a mixture of urea and melamine whose melamine/urea molar ratio may vary between 0.01 and 2, in particular between 0.02 and 1.

As formaldehyde-like compounds can be applied compounds which react in the same way as formaldehyde. Examples are formaldehyde, paraformaldehyde and trioxane. Paraformaldehyde is the polymer or oligomer form of formaldehyde which in the depolymerisation reaction splits off formaldehyde. Paraformaldehyde with a degree of polymerisation n can produce n formaldehyde molecules and thus n formaldehyde equivalents.

Examples of aminoplast resins are: melamine/formaldehyde resins, urea/formaldehyde resins, melamine/urea/formaldehyde resins, urea/phenol/formaldehyde resins and melamine/urea/phenollformaldehyde resins.

It has been found in particular that the formaldehyde emission from the final board material is considerably reduced with an adhesive composition comprising an aminoplast resin in which the F/(NH₂)₂ ratio is lower than or equal to 1. Preferably the F/(NH₂)₂ ratio is lower than 0.98; more preferably lower than 0.96, still more preferably lower than 0.95, with special preference lower than 0.94 and most preferably lower than 0.92. The F/(NH₂)₂ ratio is the molar ratio of the formaldehyde equivalents and NH₂ groups present.

The F/(NH₂)₂ ratio in the aminoplast resin is preferably greater than or equal to 0.7, more preferably greater than 0.75, still more preferably greater than 0.78, with special preference greater than or equal to 0.8 and most preferably greater than 0.82.

The invention relates furthermore to the preparation of board material by mixing and curing cellulose-containing materials with an adhesive composition according to the invention. Such curing is accomplished in a press by producing board material in the press at elevated temperature and pressure using an adhesive, the adhesive comprising the adhesive composition according to the invention, comprising an aminoplast resin and the catalysing compound according to the invention. Preferably the adhesive consists essentially or even almost entirely or entirely of the adhesive composition according to the invention. Where plywood panels are produced a thickener is normally added to the adhesive composition beforehand. This thickener may comprise any material that is readily dispersible in the adhesive and mainly serves to enhance the adhesive's filling effect and to ensure that the adhesive largely remains on the surface of the veneers used.

Preferably the present process is applied in the production of plywood, particle board, MDF board (medium density fibreboard), HDF board (high density fibre board), OSB board (oriented strand board) or on straw based panels (strawboard).

The preparation of the adhesive according to the invention by the addition of a catalyst to the resin is usually effected just before board production. The resin has at room temperature sufficient stability to be able to be stored for a few weeks.

The aminoplast resin normally has a pH of 8 or higher. If the catalysing compound according to the invention is added, it is preferred to let the pH of the adhesive composition determine the amount of catalysing compound added. Preferably, the catalysing compound according to the invention is added so as to achieve a pH of 7.5 or 7.0 or lower after addition. Preferably the pH of the mixture after addition of the catalysing compound is between 6.5 and 5.5. In an alternative embodiment, between 0.5 and 7 wt. % catalysing compound is added relative to the aminoplast resin (measured as dry catalysing compound/dry aminoplast resin). As a guideline, it holds that a decrease in the pH to which the adhesive composition according to the invention is brought typically leads to a decrease in gel time but also to a decrease in storage stability.

For the preparation of plywood panels the pH of the adhesive mixture after addition of the catalysing acid compound preferably is between 7.0 and 6.5. Alternatively for plywood production, between 0.2-1 wt % of catalysing compound according to the invention is added relative to the aminoplast resin (also measured as dry catalysing compound/dry aminoplast resin).

Between 10 seconds and 4 hours following the addition of the catalysing compound, the adhesive is used for the production of board material; preferably between 30 seconds and 120 minutes.

If as catalysing compound use is made of a compound able to release an acid, the adhesive can be used for a longer period for the production of board material. The adhesive is used after 30 seconds to 30 hours.

The period within which the adhesive can be used is dependent on many factors and can readily be determined by one skilled in the art. The period depends on amongst other things the applied catalysing compound, the temperature and the pH.

The pressing conditions during the preparation of board material depend on the type of board material. In the production of plywood, for example, a pressure is applied of 1-2 MPa, for particle board a pressure of 1-5 MPa, preferably 2-4 MPa, and for MDF a pressure of 2-7 MPa, preferably 3-6 MPa. The temperature at which the board material is produced is normally 80-140° C. for plywood, normally 180-230° C. for particle board and OSB, and normally 170-230° C. for MDF. For particle board, MDF and OSB a pressing time is applied that is expressed in seconds per mm board thickness. For OSB board the pressing time is usually 4-12 sec/mm, preferably 6-10 sec/mm. For particle board normally a pressing time of 4-12 sec/mm, preferably 5-10 sec/mm is applied. MDF boards are manufactured with a pressing time of usually 5-17 sec/mm, in particular 6-14 sec/mm. Plywood panels are usually manufactured with a pressing time of 30-70 sec/mm, in particular 40-60 sec/mm.

During the adhesive preparation waxes are normally added to the adhesive composition to make the final board material more resistant to moisture absorption. The waxes are normally emulsifying waxes or solid waxes and are produced in for example the petrochemical industry.

The invention further relates to the board material obtainable by compressing the adhesive composition according to the invention and cellulose-containing compounds.

The formaldehyde potential from this board material, in particular particle board material, according to the invention, measured by the so-called Perforator test (DIN NEN 120), can be lower than 10 mg/100 g; preferably the formaldehyde potential is lower than 8 mg/100 g; this presents the advantage that the (particle)board material according to the invention has a class 1 formaldehyde potential according to NEN EN 312-1. More preferably the formaldehyde potential is lower than 7 mg/100 g, with special preference lower than 6.5 mg/100 g or even lower than 6 mg/100 g. Most preferably the formaldehyde potential of the board material according to the invention is lower than 5 mg/100 g.

The board material according to the invention possesses good mechanical properties: the internal breaking strength, usually referred to as internal bond strength or IB, of the board material according to the invention normally passes the V100 test to NEN-EN 1087-1.

The production of plywood takes a specific position within the framework of the invention in that the molar F/(NH₂)₂ ratio of the aminoplast resins in adhesive compositions which are applied for known plywood manufacturing processes are usually higher than for the production of other types of board material, such as particle board, MDF board, HDF board or OSB. Also, the formaldehyde emission of plywood boards is often determined to different standards. The invention therefore also relates to a process for the production of plywood board material comprising the application of an adhesive composition which is cured, wherein the adhesive composition comprises a formaldehyde-containing aminoplast resin and a catalysing compound, where the catalysing compound is an acid or is able to release an acid with a pKa lower than 6 and where the formaldehyde-containing aminoplast resin possesses a F/(NH₂)₂ ratio which is lower than or equal to 1.2, preferably lower than or equal to 1.1.

The adhesive composition applied according to the invention for the production of plywood may comprise the further preferred embodiments as described above. In particular, it is preferred that the catalysing compound in the adhesive composition comprises at most 11 wt. % of an ammonium salt; more preferably, at most a lower amount as indicated earlier in preferred embodiments.

The invention also relates to plywood material obtainable by the process according to the invention. The plywood material according to the invention has the advantage that the formaldehyde emission is lower than for plywood materials produced in the known manner with a higher F/(NH₂)₂ ratio in the aminoplast resin of the adhesive composition and/or without an acid with a pKa lower than 6 as a catalyst. At the same time the plywood material according to the invention can yet exhibit excellent mechanical properties; the tensile strength according to NEN 314-1, for instance, can comply with stringent standards which require a value of at least 7 kg/cm².

The invention is further elucidated with reference to the following examples without being restricted thereto.

### EXAMPLE 1

Preparation of a Resin for Particle Board Production

26.6 parts by weight of a 50% formaldehyde solution in water was added to a reactor preheated to 50° C. The pH of the formaldehyde solution was brought to 8.0-8.5 with 2 molar of sodium hydroxide. Hereafter 13.1 parts by weight of urea were added and the temperature of the mixture was increased to 99° C. On reaching the desired temperature, the pH was lowered with 2 molar of acetic or formic acid to 4.5-5.0. This temperature and pH were maintained until the viscosity rose to 200-300 centipoise. Hereafter the pH was increased with 2 molar of sodium hydroxide to 9.0-9.5 and the temperature of the mixture was lowered to 90° C. 26.5 parts by weight of melamine and 17.6 parts by weight of a 50% formaldehyde solution were added. The reaction mixture was held for 1 hour at this temperature and pH, and then 16.3 parts by weight of urea were added. The temperature of the mixture was next lowered to 50° C. and the adhesive was drained off.

A MUF resin was obtained with F/(NH₂)₂ of 0.9.

### EXAMPLES 2-4 AND COMPARATIVE EXPERIMENTS A-B

To the MUF resin manufactured according to the procedure described in example I were added different catalysts until a pH of 6 was reached and the gel time, the Abes tensile strength after boiling, the internal bond strength of particle board after boiling and the formaldehyde potential of particle board were measured. Particle board was prepared as follows: a quantity of catalyst was added to the resins such that a gel time of approximately 60 seconds at 100° C. was obtained The catalysed resin was intensively mixed with a quantity of chips (spruce) with a blender in such a way that 10% dry resin was present on dry wood. The moisture content of the wood used was 2.2%. After mixing the resinified chips were transferred into a moulding press where they were homogeneously distributed and lightly compacted to form a sort of cake consisting of chips and resin. After removing the sides of the mould the cake was placed on the baseplate in the mould that had been brought to a temperature of 190° C. and compacted further to a particular thickness in such a way that a density of 650 kg/m³ was obtained. A press factor of 11 sec/mm was used for a panel thickness of 16 mm. After pressing the panels were cooled down and sawn to the dimensions necessary for the determination of formaldehyde potential and internal breaking strength.

The measured values are presented in the following table.

| | | | | Abes⁴⁾ | | |
|---|---|---|---|---|---|---|
| | | | | (V100) | | |
| | | | Gel | tensile | IB | F potential⁶⁾ |
| Example | MUF | | time²⁾ | strength | (V100)⁵⁾ | (Perforator) |
| or Experiment | F/(NH₂)₂¹⁾ | Catalyst | [sec] | [N] | N/mm² | [mg/100 g] |
| A | 1.1 | Ammonium | 60³⁾ | — | 1.1 | 11 |
| | | sulphate | | | | |
| B | 1.1 | Formic acid | 52 | — | 1.2 | 18 |
| 2 | 0.9 | Acetic acid | 69 | 121 | — | — |
| 3 | 0.9 | Formic acid | 58 | 116 | 1.0 | 5 |
| 4 | 0.9 | Oxalic acid | 56 | 91 | — | — |

¹⁾The ratio of 1.1 was achieved by preparing a resin as in example 1 except that the added quantity of formaldehyde was adjusted such that the desired molar F/(NH₂)₂ ratio was achieved.
²⁾For the determination of the gel time, 5 grams of catalysed resin in water were transferred to a test tube. The contents were stirred in boiling water until a gel was formed. The associated time is the gel time.
³⁾3% ammonium sulphate was added 5 grams of resin (dry/dry), after which the gel time was measured according to 2).
⁴⁾For the determination of the tensile strength 2 mg of catalysed resin was brought between two rods of beech veneer (0.75 × 20 × 117 mm) and cured for 60 sec at 140° C. (ABES method (Automated Bonding Evaluation)), after which the tensile strength after boiling was measured according to the procedure developed by Prof.Ph . . . E. Humphrey, described in U.S. Pat. No. 5176028.
⁵⁾The internal bondstrength was measured according to EN 319 after boiling for two hours according to NEN-EN 1087-1 (V100 test). The specification referred to in EN 312-5 for load-bearing board material for use in damp conditions for the particle boards prepared here amounts to at least 0.14 N/mm².
⁶⁾The formaldehyde potential was determined according to NEN-EN 120 (Perforator test).

Comparative experiment A yields a reference material with a standard F/(NH₂)₂ of 1.1 and ammonium sulphate as a catalyst; the formaldehyde potential is 11 mg/100 g, which is undesirably high.

Comparative experiment B demonstrates that in particle board a combination of a normal F/(NH₂)₂ ratio of 1.1 and formic acid as a catalyst results in a still higher formaldehyde potential than is usual for such a resin system.

Example 2 demonstrates that when the pKa value of the acid is between 4 and 5, the gel time increases to values which are somewhat higher than usual for this type of resins, but that the achievable mechanical properties of final products produced using this adhesive composition can be very good—as illustrated by the ABES tensile strength—despite the low F/(NH₂)₂ ratio of less than 1.

Example 3 shows that the monoacid formic acid in combination with a F/(NH₂)₂ ratio below 1 leads to a board material with a high tensile strength, good IB and a very low formaldehyde potential. The low formaldehyde potential of Example 3 is particularly surprising in view of Comparative experiment B.

From Example 4 it appears, in comparison with Example 3, that the monoacid formic acid leads to a higher tensile strength than the diacid oxalic acid.

### EXAMPLE 5 AND COMPARATIVE EXPERIMENT

Preparation of a Resin for Plywood Production

To a glass reactor were added 593 parts by weight of 37.6% formaldehyde solution in water. With 2 molar of (sodium) hydroxide the pH of the formaldehyde solution was brought to 7.5-8.1, after which 194 parts by weight of urea and 41 parts by weight of melamine were metered.

The temperature was increased to 90° C. 5 minutes after reaching the desired temperature the pH was lowered with 2 molar of formic acid to 4.8-5.2. After reaching the cloud point at room temperature the pH was increased with 2 molar of (sodium) hydroxide to 8.5 and the temperature of the reaction mixture was lowered to 88° C. Next 380 parts by weight of melamine and 396 parts by weight of 37.6% formaldehyde solution were added. The reaction mixture was held for 1 hour at this temperature and pH, after which it was cooled to 78° C. Then 152 parts by weight of urea were added and condensed to a viscosity of 50 centipoise. The mixture was subsequently cooled to 30° C.

A MUF resin was obtained with F/(NH₂)₂ of 1.1.

Preparation of Plywood Boards (5 layers)

A catalyst was added to the aforementioned resin until the desired gel time of 160 sec at 100° C. was obtained. Next flour was added to achieve a viscosity of approximately 2000 cPs. This adhesive mixture was applied in the preparation of 5-layer plywood. To that end use was made of red meranti veneers which were conditioned to a moisture content of 10%. For each board 3 core layers of veneer with a thickness of 3.7 mm and two face layers of 1.8 mm were used. The veneers were stacked crosswise on each other with adhesive mixture being well distributed on the intermediate seams in an amount of 200 g/m².

Following adhesive application and stacking, the package was cold compressed for 30 minutes at a pressure of 10 bar. After heating the press, compression/curing was effected for 12 minutes at a temperature of 120° C. The panels were then taken from the press and cooled.

Formaldehyde emission and IB were determined as quickly as possible after board production according to the Japanese Agricultural standard JAS (JAS 987 2000 for structural plywood).

| | | | | | IB after | |
|---|---|---|---|---|---|---|
| | | | | Abes³⁾ | cyclic | |
| | | | Gel | (V100) | boiling | F emission⁵⁾ |
| | | | time²⁾ | tensile | test⁴⁾ | JAS |
| Example | MUF | | (100° C.) | strength | (JAS) | exsiccator) |
| or Experiment | F/(NH₂)₂¹⁾ | Catalyst | [sec] | [N] | [kg/cm²] | [mg/100 ml] |
| C | 1.2 | NH₄Cl | 160⁶⁾ | 137 | 8.8 | 0.4 |
| 5 | 1.1 | HCOOH | 160 | 124 | 7.7 | 0.3 |

¹⁾The ratio of 1.2 was achieved by preparing resin as in Example 5, the added quantity of formaldehyde being increased such that the desired molar F/(NH₂)₂ ratio was achieved.
²⁾For the determination of the gel time 5 grams of catalysed resin in water were transferred to a test tube. The contents were stirred in boiling water until a gel was formed. The associated time is the gel time.
³⁾For the determination of the ABES tensile strength 2 mg of catalysed resin was brought between two rods of beech veneer (0.75 × 20 × 117 mm) and cured for 60 sec at 140° C. (ABES method (Automated Bonding Evaluation)), after which the tensile strength after boiling was measured according to the procedure developed by Prof.Ph.E. Humphrey and described in U.S. Pat. No. 5176028.
⁴⁾The internal bond strength (tensile strength IB) was measured on 5-layer plywood test specimens after the following cyclic boiling test: 1. Immersion in boiling water for 4 hours 2. Drying for 16-20 hours at 60 ± 3° C. in a ventilated oven 3. Immersion in boiling water again for 4 hours 4. Cooling in water of 20° C.
The IB was measured crosswise as shear tensile strength in wet condition within 4 hours after step 3. According to the JAS (JAS 987 2000 for structural plywood) the Type I specification value for moisture-resistant plywood panel is 7.0 kg/cm² at the minimum.
⁵⁾Formaldehyde emission was measured according to the exsiccator method described in JAS (JAS 987 2000 for structural plywood). Here 10 test panels of 150 by 50 mm were placed in an exsiccator over 300 ml of water for 24 hours. After this period formaldehyde is measured in the aqueous phase.
⁶⁾For obtaining the gel time either solid ammonium chloride was added to the resin in the case of the reference, or a 50% formic acid solution. In the latter case the pH of the acidified resin is about 6.6

Example 5 demonstrates that the formaldehyde (F) emission of plywood according to the invention, i.e. 0.3 mg/100 ml is significantly lower than the F emission of the known plywood, as shown in the comparative experiment, while the mechanical properties of the plywood according to the invention, particularly the IB after boiling in water, still comply with the JAS standard.

1. Adhesive composition comprising a formaldehyde-containing aminoplast resin and a catalysing compound, characterised in that the catalysing compound is an acid or is able to release an acid with a pKa lower than 6, under the proviso that the catalysing compound comprises at most 11 wt. % of an ammonium salt, and in that the formaldehyde-containing aminoplast resin has a F/(NH2)2 ratio which is lower than or equal to 1.

2. Adhesive composition according to claim 1, characterised in that the catalysing compound is an acid or is able to release an acid with a pKa lower than 5.

3. Adhesive composition according to claim 1, characterised in that the catalysing compound is a monoacid or a methyl ester, melamine salt or urea salt of one or more monoacids with a pKa lower than 4 or a methylolated urea or melamine compound esterified with one or more monoacids with a pKa lower than 4.

4. Adhesive composition according to claim 3, characterised in that the catalysing compound is formic acid or a methyl ester, melamine salt or urea salt of formic acid or a methylolated urea or melamine compound esterified with formic acid.

5. Adhesive composition according to claim 4, characterised in that the catalysing compound is formic acid.

6. Adhesive composition according to claim 1, characterised in that the catalysing compound is acetic acid.

7. Adhesive composition according to claim 1, characterised in that the pH of the adhesive composition is lower than or equal to 7.

8. Adhesive composition according to claim 7, characterised in that the pH of the adhesive composition is 6.5-5.5.

9. Process for the preparation of a board material by mixing cellulose-containing compounds with the adhesive composition according to claim 1 and curing the same.

10. Board material obtainable according to claim 9.

11. Board material according to claim 10 whose formaldehyde potential according to DIN NEN 120 is lower than 8 mg/100 g.

12. Board material according to claim 11 whose formaldehyde potential according to DIN NEN 120 is lower than 6.5 mg/100 g.

13. Board material according to claim 10 whose internal bond strength complies with the specification stated in EN 312-5 for load-bearing board material for use in damp conditions measured according to NEN-EN 1087-1 (V100).

14. Process for the preparation of a plywood board material comprising the application of an adhesive composition which is cured, characterised in that an adhesive composition according to claim 1 is applied, with the formaldehyde-containing aminoplast resin possessing a F/(NH2)₂ ratio lower than 1.2.

15. Plywood material obtainable according to the process of claim 14.

16. Plywood material according to claim 15 whose tensile strength according to the JAS is at least 7 kg/cm2.

17. Plywood material according to claim 15 whose formaldehyde emission according to the JAS is not more than 0.3 mg/100 ml of water.
